(19) United States
(12) Patent Application Publication
(10) Pub. No.: US 2018/0013897 A1
(43) Pub. Date: Jan. 11, 2018

(54) SELECTION OF A SUBSCRIPTION AT A DEVICE

(71) Applicant: QUALCOMM Incorporated, San Diego, CA (US)

(72) Inventors: Akash KUMAR, Hyderabad (IN); Ankit MAHESHWARI, Hyderabad (IN); Suresh SANKA, Hyderabad (IN)

(21) Appl. No.: 15/206,139

(22) Filed: Jul. 8, 2016

(51) Int. Cl. H04M 15/00; H04L 12/741; H04W 8/04; H04W 8/18; H04W 48/18; H04L 12/26; H04W 88/16; H04W 80/04; H04W 88/06

(52) U.S. Cl. CPC H04M 15/8061; H04W 48/18; H04L 45/745; H04W 8/04; H04L 43/16; H04W 8/183; H04W 80/04; H04W 88/06; H04W 88/16

(57) ABSTRACT

A communication device may be configured to access a plurality of subscriptions for a plurality of providers. For example, a communication device may be configured with at least one subscriber identity module (SIM). For a communication device having a plurality of subscriptions accessible thereto, the selection of a subscription to connect to a destination network may be configurable. The selection of a subscription from a plurality of available subscriptions may be based on a cost (e.g., financial cost, data cost, or another resource) associated with connecting to a destination network using different subscriptions. For example, a first subscription may be selected if connection to the destination network is more expensive using a second subscription and/or if the balance on the second subscription is too low.

### BACKGROUND

### Field

The present disclosure relates generally to communication systems, and more particularly, to a communication device having access to a plurality of subscriptions for connecting to one or more networks.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

### SUMMARY

The following presents a simplified summary of one or more aspects in order to provide a basic understanding of such aspects. The summary is not an extensive overview of all contemplated aspects, and is intended to neither identify key or critical elements of all aspects nor delineate the scope of any or all aspects. The summary's sole purpose is to present some concepts of one or more aspects in a simplified form as a prelude to the more detailed description that is presented later.

Network providers may offer different rates to use different networks. That is, a first cost (e.g., financial cost, data cost, or some other resource cost) associated with connecting to a first network using a provider may be different than a second cost associated with connecting to a second network using that provider. Additionally, the cost may vary according to time of day, congestion on a network, and other factors—e.g., a cost associated with connecting to a network at a peak time of day may be greater than another cost associated with connecting to a network at an off-peak time of day.

According to aspects, a communication device may be configured to access a plurality of subscriptions for a plurality of providers. For example, a communication device may be configured with at least one subscriber identity module (SIM). For a communication device having a plurality of subscriptions accessible thereto, the selection of a subscription to connect to a destination network may be configurable. The selection of a subscription from a plurality of available subscriptions may be based on a cost (e.g., financial cost, data cost, or some other resource cost) associated with connecting to a destination network using different subscriptions. For example, a first subscription may be selected if connection to the destination network is more expensive using a second subscription and/or if the available balance on the second subscription is too low.

In an aspect of the disclosure, a method, a computer-readable medium, and an apparatus are provided. The apparatus may be configured to identify a destination network. The apparatus may be further configured to determine a first cost associated with connection to the destination network using a first subscription of the apparatus. The apparatus may be further configured to determine a second cost associated with connecting to the destination network using a second subscription of the apparatus. The apparatus may be configured to select the first subscription or the second subscription based on the first cost and the second cost. The apparatus may be further configured to connect to the destination network using the selected subscription.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4 is a diagram of a wireless communications system.

FIG. 5 is a diagram of a lookup table for wireless communications.

FIG. 6 s a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

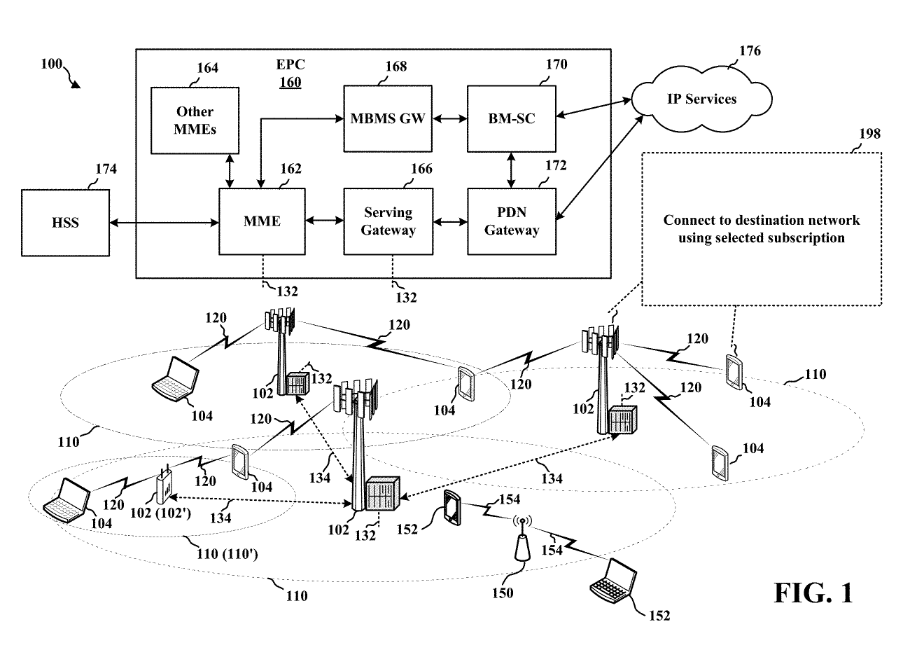

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to connect 198 to a destination network using a selected subscription, such as a destination network accessible through eNB 102.

According to aspects, the UE 104 may be configured to access a plurality of subscriptions for a plurality of providers, such as a network accessible through eNB 102. For example, a communication device may be configured with at least one subscriber identity module (SIM). For a communication device having a plurality of subscriptions accessible thereto, the selection of a subscription to connect to a destination network may be configurable. The selection of a subscription from a plurality of available subscriptions may be based on a cost (e.g., financial cost, data cost, or some other resource cost) associated with connecting to a destination network using different subscriptions. For example, a first subscription may be selected if connection to the destination network is more expensive using a second subscription and/or if the balance on the second subscription is too low (e.g., below a threshold).

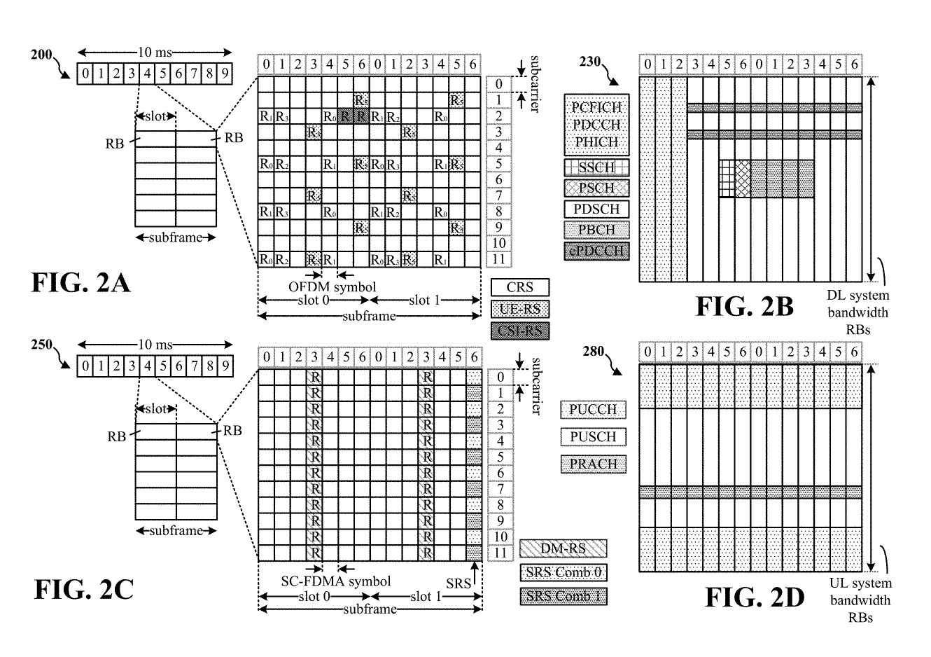

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (HACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

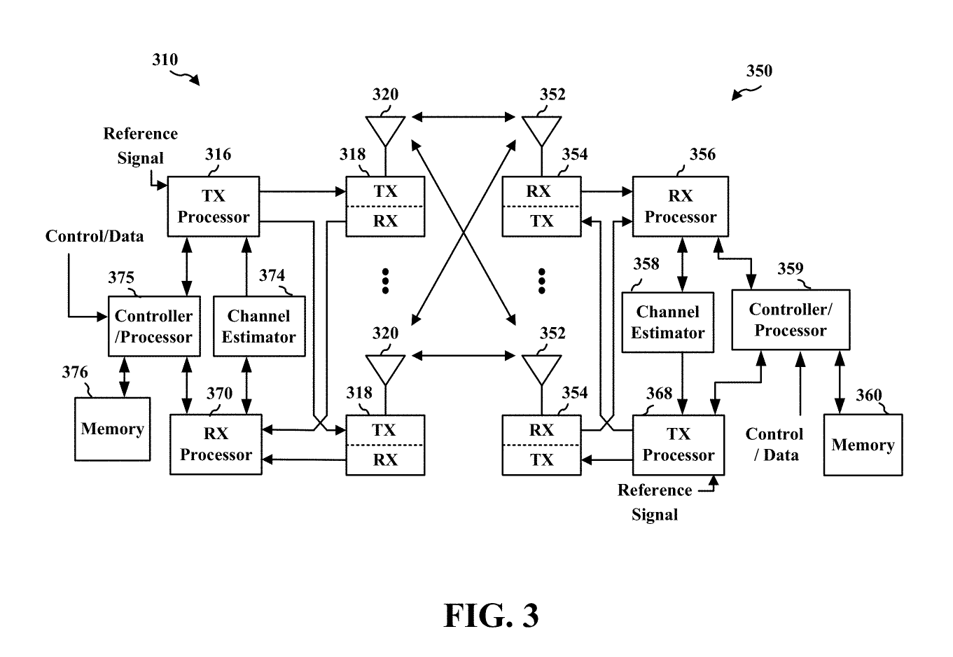

FIG. 3 is a block diagram of an eNB 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the eNB 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

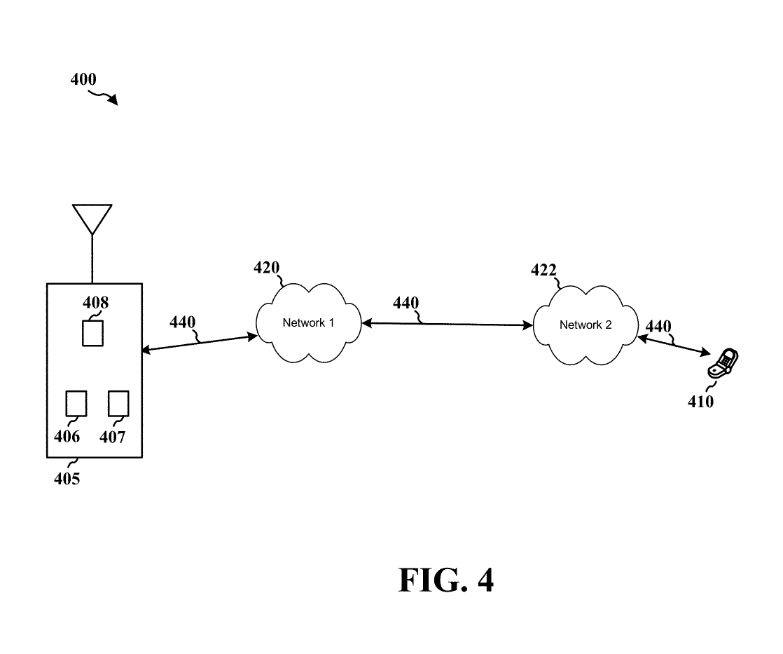

FIG. 4 is a diagram of a wireless communications system 400. The wireless communications system 400 includes at least two UEs 405, 410. In an aspect, the first UE 405 may be configured to use different network providers to connect to different networks. The first UE 405 may be configured to select a respective subscription associated with a respective network provider, for example, by using a respective SIM 406, 407, 408. According to an aspect, a SIM 406, 407, 408 may be an integrated circuit that stores an international mobile subscriber identity (IMSI) and other information (e.g., a key) used to identify and/or authenticate the first UE 405 as having a subscription for network connectivity.

The wireless communications system 400 may include at least two networks 420, 422. In an aspect, the at least two networks 420, 422 may be the same network. In another aspect, the first network 420 may be a home network or origin network—that is, a network on which communication 440 from the first UE 405 originates based on which SIM 406, 407, 408 is used. The second network 422 may be a destination network—that is, a network which communication 440 traverses in order to reach a destination system (e.g., the second UE 410), such as when a voice call or a data session between the first UE 405 and second UE 410 is initiated.

A respective cost (e.g., financial cost, data cost, a time cost, or some other resource cost) associated with connecting to the destination network 422 using different subscriptions available via SIMs 406, 407, 408 may be different. Additionally, for each subscription provided via SIM 406, 407, 408, a respective cost may vary according to time of day, congestion on one or more networks 420, 422, and other factors—e.g., a cost associated with connecting to a network at a peak time of day may be greater than another cost associated with connecting to a network at an off-peak time of day. In various aspects, the first UE 405 may be configured to select a SIM 406, 407, 408 that minimizes cost and/or improves reliability when connecting to the destination network 422 for communication 440.

According to an aspect, the first UE 405 may receive a destination for communication 440. For example, the first UE 405 may receive a destination number at which the second UE 410 may be reached, a destination address (e.g., a uniform resource identifier (URI)) as which the second UE 410 may be reached, and the like. In an aspect, the destination for communication 440 may be received as user input, such as through a user input of the first UE 405.

According to an aspect, the first UE 405 may identify the destination network 422 based on the received destination (e.g., the received destination number, the received destination address, etc.). For example, the first UE 405 may determine the destination network 422 based on accessing a server and/or external database that includes information indicating the destination network 422 corresponding to the second UE 410. In another example, the first UE 405 may be configured to access stored data that maps the received destination for the second UE 410 (e.g., a destination number for the second UE 410, a destination address for the second UE 410, etc.) to the destination network 422. The first UE 405 may need to connect to the destination network 422 using one of the SIMs 406, 407, 408 to establish communication 440 with the second UE 410.

According to an aspect, the first UE 405 may determine a first cost associated with connecting to the destination network 422 using a first subscription provided through a first SIM 406. In one aspect, the cost may be a cost per unit of time—e.g. three cents per minute. In another aspect, the cost may be an amount of data required to connect to the destination network. In another aspect, the cost may be a cost per unit of data required for a connection to the destination network. Additionally, the first UE 405 may determine a second cost associated with connecting to the destination network 422 using a second subscription provided through a second SIM 407.

In various aspects, the first UE 405 may further include a third SIM 408, according to which the first UE 405 may determine a third cost associated with connecting to the destination network 422 using a third subscription. The plurality of SIMs 406, 407, 408 are to be regarded as illustrative, and the first UE 405 may include any number of subscriptions.

In one aspect, the first UE 405 may access a lookup table that includes entries indicating costs associated with connecting to the destination network 422 using the subscriptions provided through the SIMs 406, 407, 408. For example, the lookup table may include a first entry indicating the first cost, and the first entry may correspond to connecting to the destination network 422 using the first subscription. Similarly, the lookup table may include a second entry indicating the second cost, and the second entry may correspond to connecting to the destination network 422 using the second subscription.

According to one aspect, the first UE 405 may be configured to construct the lookup table based on the subscriptions available at the device through the plurality of SIMs 406, 407, 408.

In one aspect, the first UE 405 may be configured to construct the lookup table based on historical data that is observed during the course of connections to destination networks (e.g., the destination network 422). For example, the first UE 405 may determine a first balance associated with the first subscription prior to connecting to the destination network 422 and, further, determine a second balance associated with the first subscription after the connection to the destination network 422 has ended. The first UE 405 may subtract the second balance from the first balance and divide the difference by a duration of the connection to the destination network (e.g., a duration of a call, a duration of a data session, etc.). The first UE 405 may enter the quotient into the lookup table as the cost per unit of time corresponding to connecting to the destination network 422 using the first subscription. Additional entries may be similarly entered into lookup table for the second subscription using the second SIM 407 and/or the third subscription using the third SIM 408.

In another aspect, the first UE 405 may be configured to construct the lookup table based on connecting to a server and/or external database. The first UE 405 may request information indicating a cost associated with connecting to the destination network using the first, second, and/or third subscriptions. Based on the received information, the first UE 405 may determine one or more entries for the lookup table indicating a cost associated with connecting to the destination network 422 using a subscription corresponding to a respective SIM 406, 407, 408.

In an aspect, the first UE 405 may use a combination of approaches (e.g., observation of historical data, retrieval of information from a server and/or database, etc.) to construct the lookup table. In an aspect, the first UE 405 may be configured to update the lookup table based on one or more approaches (e.g., observation of historical data, retrieval of information from a server and/or database, etc.). In an aspect, the first UE 405 may be configured to update the lookup table based on any additional information, such as information associated with a subscription. For example, if the first subscription includes “free” minutes (e.g., the subscription provider may not track (e.g., charge for) minutes during off-peak hours), then the first UE 405 may update the lookup table to reflect this “free” cost. In another example, the first UE 405 may be further configured to update one or more lookup tables based a time of data at which the first UE 405 connects to the destination network—e.g., the first UE 405 may observe different costs to connecting to the destination network 422 at different times of day and update or add an entry in one or more lookup tables reflecting the cost during that time.

According to one aspect, the first UE 405 may include a plurality of lookup tables. For example, a cost associated with connecting to the destination network 422 may vary according to a time of day. In connection therewith, the first UE 405 may include a respective lookup table corresponding to a respective time frame. Accordingly, the first UE 405 may access a respective lookup table corresponding to a time at which a connection to the destination network 422 is initiated. According to another example, a cost associated with connecting to the destination network 422 may vary according to a region (e.g., a geographical region in which the first UE 405 is located). In connection therewith, the first UE 405 may include a respective lookup table corresponding to a respective region. Accordingly, the first UE 405 may determine the region in which the first UE 405 is located (e.g., using GPS, network connectivity information, or another approach to location determination) and may access a respective lookup table corresponding to the region in which the first UE 405 is located.

According to an aspect, the first UE 405 may be configured to select a subscription based on a balance associated with that subscription. For example, the first UE 405 may be configured to determine a balance associated with the first subscription using the first SIM 406, such as where the first subscription is prepaid or where the first subscription is allocated an amount of data for one or more data sessions. The first UE 405 may compare the determined balance to a predetermined threshold and, based on the comparison, the first UE 405 may determine whether the first subscription should be used (e.g., if the determined balance does not meet or exceed the threshold, the first UE 405 may determine that the balance is too low to use the first subscription). In such an aspect, the first UE 405 may select the second subscription or the third subscription. In one aspect, if all balances for all subscriptions do not satisfy a predetermined threshold, the first UE 405 may provide an alert to a user (e.g., an alert indicating a duration or an amount of data available for connecting to the destination network 422). In another aspect, if all balances for all subscriptions do not satisfy a predetermined threshold, the first UE 405 may select a subscription corresponding to a SIM 406, 407, 408 having a greatest balance.

In various aspects, the first UE 405 may be configured to determine the first cost associated with the first subscription and the second cost associated with the second subscription, and subsequently select one of the subscriptions, prior to determining an available balance for the selected subscription. If the balance of the selected subscription is too low, the first UE 405 may select another subscription. Therefore, the first UE 405 may select another subscription if the available balance for the first selected subscription does not satisfy the predetermined threshold.

According to an aspect, the first UE 405 may be configured to select a subscription based on a configurable preference. In one aspect, the first UE 405 may receive an indication of a preferred subscription corresponding to one of the SIMs 406, 407, 408 and the first UE 405 may determine a selected subscription based on the indication of the preferred subscription. For example, the first UE 405 may determine the first cost associated with a preferred subscription, e.g., the first subscription and the second cost associated with the second subscription and, if a difference between the first cost and the second cost is within a threshold margin, the first UE 405 may select the preferred subscription (which may be configured by a user as a preferred subscription). In another aspect, the configurable preference may override the cost difference—e.g., the user may prefer to use a preferred subscription regardless of cost.

Based at least on the determined costs associated with connecting to the destination network 422 using a respective subscription, the first UE 405 may be configured to select a subscription to use to connect to the destination network 422. From the selected subscription, the first UE 405 may use the one of the SIMs 406, 407, 408 corresponding to the selected subscription and, accordingly, connect to the destination network 422 to contact the second UE 410.

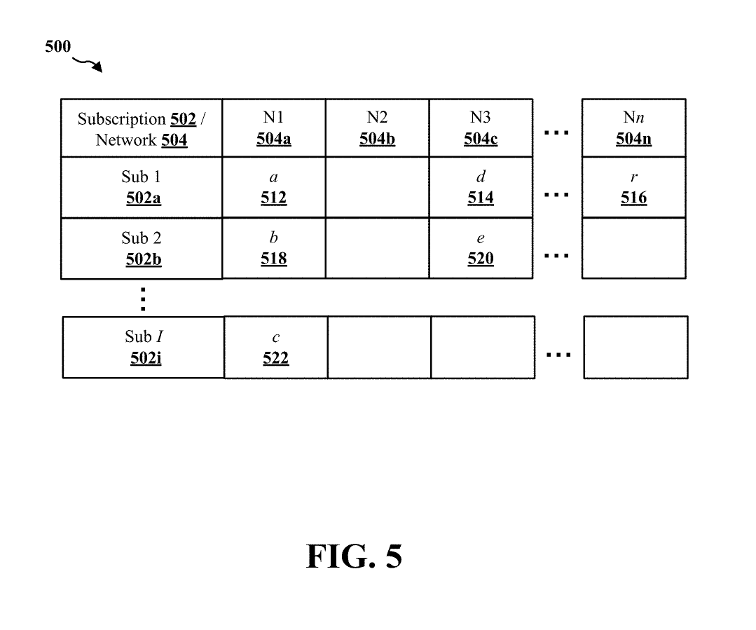

FIG. 5 illustrates an a lookup table 500, according to an aspect. In the context of FIG. 4, the first UE 405 may include the lookup table 500—e.g., the lookup table 500 may be stored in the first UE 405 as one or more data structures. The first UE 405 may be configured to construct and/or update the lookup table 500, as described herein. In an aspect, one of the networks 504a, 504b, 504c, 504n may correspond to the destination network 422. In an aspect, a respective subscription 502a, 502b, 502i may correspond to a respective SIM 406, 407, 408 available at the first UE 405.

In an aspect, the lookup table 500 may include information corresponding to any number of networks 504a, 504b, 504c, . . . , 504n, for example, for which the first UE 405 may have cost information. In an aspect, the lookup table 500 may include information corresponding to any number of subscriptions 502a, 502b, . . . , 502i, for example, for which the first UE 405 includes a SIM 406, 407, 408, etc.

In an aspect, the lookup table 500 includes a plurality of entries 512, 514, 516, 518, 520, 522. Each of the entries 512, 514, 516, 518, 520, 522 may represent a cost associated with connecting to a network 504 using a subscription 502. For example, a first entry 512 may represent a cost associated with connecting to a first network 504a using a first subscription 502a. Similarly, a second entry 514 may represent a cost associated with connecting to a third network 504c using the first subscription 502a. Similarly, a fifth entry 520 may represent a cost associated with connecting to the third network 504c using a second subscription 502b.

According to various aspects, the lookup table 500 may not include entries representing costs associated with connecting to each network 504 using each subscription. For example, the lookup table 500 may not include an entry representing a cost associated with connecting to a second network 504b using the first subscription 502a (e.g., such information may be unavailable to the first UE 405, such as where the first UE 405 lacks historical data indicating such information). In an aspect, absent (e.g., null or blank) entries may be not be considered when selecting a subscription. In another aspect, absent entries may not disqualify a subscription, such as where a subscription is configured as preferred regardless of cost (e.g., if the first subscription 502a is configured as preferred, then the first subscription 502a may be selected to connect to the second network 504b even though the lookup table 500 does not include an entry representing the cost to connect to the second network 504b using subscription 502a).

According to one illustrative aspect, the first UE 405 may receive a destination for communication 440, such as a destination number or destination address associated with the second UE 410. Based on the destination for communication 440, the first UE 405 may be configured to determine the destination network 422. For example, the first UE 405 may contact a server and/or external database to determine the destination network 422, or the first UE 405 may include stored data that indicates the destination network 422. In some aspects, one or more entries (e.g., entries 512, 514) may point to other tables that include costs by time of day, costs for data, voice, video streaming, and the like.

According to one example, the destination network 422 may correspond to the first network 504a, and the first UE 405 may be configured to select a subscription 502 based on the subscriptions 502a, 502b, 502i available to the first UE 405. In aspects, the first UE 405 may be configured to compare a first value for the first entry 512 to a second value for the fourth entry 518 and to a third value for the sixth entry 522. In the illustrated example, the first value is less than both the second value and the third value, and therefore the first UE 405 may be configured to select the first subscription 502a to connect to the first network 504a. In an aspect, the first subscription 502a may correspond to the first SIM 406.

According to another example, the destination network 422 may correspond to the third network 504c, and the first UE 405 may be configured to select a subscription 502 based on the subscriptions 502a, 502b available to the first UE 405. In aspects, the first UE 405 may be configured to compare a first value for the second entry 514 to a second value for the fifth entry 520. In the illustrated example, the first value is less than the second value. The first UE 405 may be configured to compare a balance associated with the first subscription 502a to a predetermined threshold and, if the balance does not satisfy (e.g., meet or exceed) the threshold, then the first UE 405 may be configured to select the second subscription 502b.

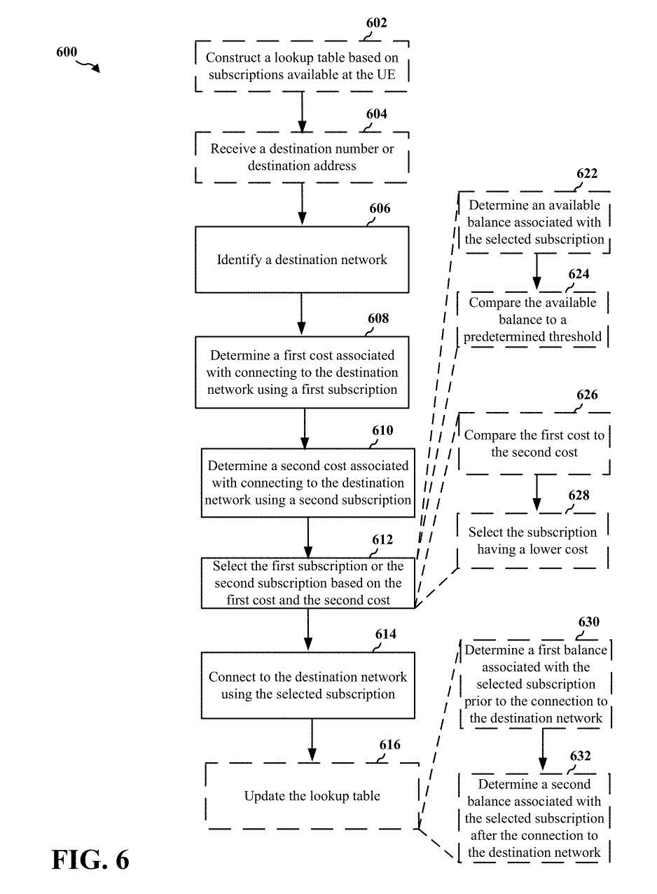

FIG. 6 is a flowchart 600 of a method of wireless communication. The method may be performed by a UE (e.g., the first UE 405, the apparatus 702/702′). Although FIG. 6 illustrates a plurality of operations, one of ordinary skill will appreciate that one or more operations may be transposed and/or contemporaneously performed. Further, one or more operations of FIG. 6 may be optional (e.g., as denoted by dashed lines) and/or performed in connection with one or more other operations.

Beginning first with operation 602, the UE may be configured to construct a lookup table based on subscriptions available at the UE. For example, the UE may contact an external server to populate entries of the lookup table and/or observe historical data associated with connecting to a destination network using the available subscriptions. In the context of FIG. 4, the first UE 405 may be configured to construct a lookup table based on the SIMs 406, 407, 408 available at the first UE 405. In the context of FIG. 5, the UE may be configured to construct the lookup table 500.

At operation 604, the UE may receive a destination number or destination address. For example, the UE may receive an input that indicates a destination number for a voice call or indicates a destination address for a data session or a URL for a video streaming session. In the context of FIG. 4, the first UE 405 may receive a destination number or destination address associated with the second UE 410.

At operation 606, the UE may identify a destination network. In various aspects, the UE may be configured to identify the destination network based on the destination number or destination address. For example, the UE may contact an external server or the UE may include stored data that identifies a destination network corresponding to the destination number or destination address. In the context of FIG. 4, the first UE 405 may be configured to identify the destination network 422 on which the second UE 410 may be reached. In the context of FIG. 5, the UE may identify a network to which the UE wishes to connect.

At operation 608, the UE may determine a first cost associated with connecting to the destination network using a first subscription of the UE. In the context of FIG. 4, the first UE 405 may be configured to determine a first cost associated with connecting to the destination network 422 using the first subscription available through the first SIM 406. In the context of FIG. 5, the UE may be configured to identify a cost from an entry (e.g., the first entry 512) corresponding to connecting to a destination network (e.g., the first network 504a) using a first subscription (e.g., the first subscription 502a).

At operation 610, the UE may determine a second cost associated with connecting to the destination network using a second subscription of the UE. In the context of FIG. 4, the first UE 405 may be configured to determine a second cost associated with connecting to the destination network 422 using the second subscription available through the second SIM 407. In the context of FIG. 5, the UE may be configured to identify a cost from an entry (e.g., the fourth entry 518) corresponding to connecting to a destination network (e.g., the first network 504a) using a second subscription (e.g., the second subscription 502b).

At operation 612, the UE may select the first subscription or the second subscription based on the first cost and the second cost. In the context of FIG. 4, the first UE 405 may configured to select either the first SIM 406 or the second SIM 407 to use for connecting to the destination network 422. In the context of FIG. 5, the UE may be configured to select the first subscription 502a or the second subscription 502b based on the respective costs indicated in respective entries 512, 518).

In an aspect, operation 612 may include operation 622 and/or operation 624. At operation 622 the UE may determine an available balance associated with the selected subscription. In the context of FIG. 4, the first UE 405 may be configured to determine an available balance for the selected subscription corresponding to the selected SIM (e.g., the first SIM 406). In the context of FIG. 5, the UE may determine a balance associated with the first subscription 502a (when the first subscription 502a is selected over the second subscription 502b).

At operation 624, the UE may compare the available balance for the selected subscription to a predetermined threshold. If the available balance does not satisfy the predetermined threshold (e.g., does not meet or exceed the predetermined threshold), then the UE may select another subscription (e.g., the second subscription) or perform another operation to indicate that the available balance does not satisfy the predetermined threshold. In the context of FIG. 4, the first UE 405 may be configured to select another subscription corresponding to another SIM (e.g., the second SIM 407). In the context of FIG. 5, the UE may select a second subscription 502b for connecting to the first network 504a.

In an aspect, operation 612 may include operation 626 and/or operation 628. At operation 626 the UE may compare the first cost to the second cost. In the context of FIG. 4, the first UE 405 may be configured to compare the first cost (e.g., the cost associated with connecting to the destination network 422 using the first SIM 406) to the second cost (e.g., the cost associated with connecting to the destination network 422 using the second SIM 407). In the context of FIG. 5, the UE may compare a value for the first entry 512 to a value for the fourth entry 518.

At operation 628, the UE may select the subscription corresponding to the lowest cost. In the context of FIG. 4, the first UE 405 may be configured to select the first subscription corresponding to the first SIM 406 if the cost associated with connecting to the destination network 422 using the first SIM 406 is lower than the cost associated with connecting to the destination network 422 using the second SIM 407. In the context of FIG. 5, the UE may select the subscription 502a for connecting to the first network 504a if a value for the first entry 512 is lower than a value for the fourth entry 518.

At operation 614, the UE may connect to the destination network using the selected subscription. In the context of FIG. 4, the first UE 405 may be configured to connect to the destination network 422 using the one of the SIMs 406, 407, 408 corresponding to the selected subscription, for example, so that the first UE 405 may initiate communication 440 (e.g., a voice call or data session) with the second UE 410. In the context of FIG. 5, the UE may be configured to connect to the first network 504a using the selected subscription (e.g., the first subscription 502a).

At operation 616, the UE may be configured to update the lookup table. In the context of FIG. 4, the first UE 405 may be configured to update the lookup table. In the context of FIG. 5, the UE may be configured to update the lookup table 500.

In an aspect, operation 616 includes operation 630 and/or operation 632. At operation 630, the UE may determine a first balance associated with the selected subscription prior to connecting to the destination network. In the context of FIG. 4, the first UE 405 may determine a first balance associated with the selected subscription prior to connecting to the destination network 422. In the context of FIG. 5, the UE may determine a first balance associated with the selected subscription (e.g., the first subscription 502a) prior to connecting to the destination network (e.g., the first network 504a).

At operation 623, the UE may determine a second balance associated with the selected subscription after to connecting to the destination network (e.g., after the connection to the destination network is terminated). In the context of FIG. 4, the first UE 405 may determine a second balance associated with the selected subscription after connecting to the destination network 422 (e.g., after the connection to the destination network 422 is terminated). In the context of FIG. 5, the UE may determine a second balance associated with the selected subscription (e.g., the first subscription 502a) after the connection to the destination network (e.g., the first network 504a). For example, the UE may query a network after the connection to determine an available balance.

In an aspect, the UE may compute a quotient by subtracting the second cost from the first cost and dividing the difference by a duration of the connection. The quotient may represent a cost for connecting to the destination network. The UE may update the cost for connecting to the destination network in the appropriate entry in the lookup table using the quotient. In the context of FIG. 4, the first UE 405 may update a lookup table using such a quotient that is determined after communication 440 has ended. In the context of FIG. 5, an entry (e.g., the first entry 512) may be updated using a such quotient (e.g., when the first subscription 502a is used to connection to the first network 504a).

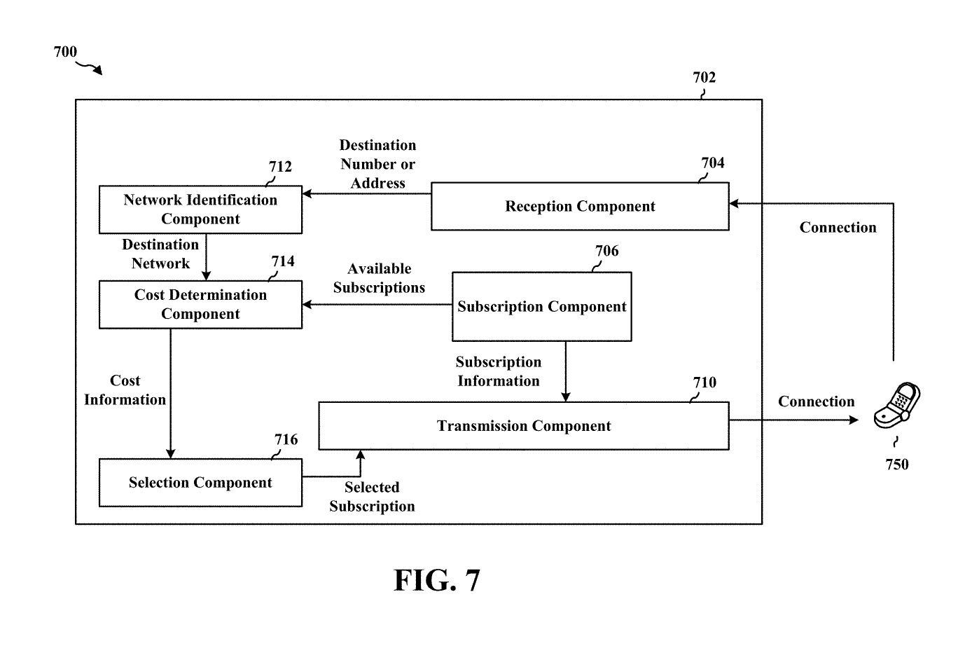

FIG. 7 is a conceptual data flow diagram 700 illustrating the data flow between different means/components in an exemplary apparatus 702. The apparatus may be a UE (e.g. the first UE 405). The apparatus includes a reception component 704 that may be configured to receive data for a connection with another UE (e.g., a second UE 750). The apparatus may further include a transmission component 710 that may be configured to transmit data for a connection with another UE (e.g., the second UE 750).

In an aspect, the reception component 704 may be configured to provide a destination number or destination address to a network identification component 712. In other aspects, the network identification component 712 may receive a destination number or destination address according to a different approach. From the destination number or destination address, the network identification component 712 may be configured to identify a destination network. For example, the network identification component 712 may request information from a server and/or external database for identifying a destination network based on the destination number or destination address. In another aspect, the network identification component 712 may access stored data to identify the destination network, for example, based on the destination number or destination address. The network identification component 712 may be configured to provide the destination network to a cost determination component 714.

In an aspect, the apparatus 702 may further include a subscription component 706. The subscription component 706 may be configured to determine subscriptions that are available for use by the apparatus (e.g., to connect to a destination network). In an aspect, the subscription component 706 may be configured to detect one or more SIMs available at the apparatus 702. From each SIM, the subscription component 706 may be configured to determine a respective subscription. The subscription component 706 may be configured to provide an indication of the available subscriptions to the cost determination component 714.

In an aspect, the cost determination component 714 may be configured to determine a first cost associated with connecting to the destination network using a first subscription of the apparatus 702 and to determine a second cost associated with connecting to the destination network using a second subscription of the apparatus 702. In an aspect, the cost determination component 714 may be configured to access a lookup table to determine the first cost and the second cost. In various aspects, the cost determination component 714 may be configured to construct and/or update the lookup table.

The cost determination component 714 may be configured to provide, to a selection component 716, at least the first cost and the second cost (as well as any additional determined costs, if there are more than two subscriptions available according to the subscription component). The selection component 716 may be configured to select the first subscription or the second subscription based on the first cost and the second cost. In an aspect, the selection component 716 may be configured to compare the first cost to the second cost and select a subscription corresponding to the lower of the two costs. In an aspect, the selection component 716 may be configured to compare a balance associated with the selected subscription to a predetermined threshold. If that balance does not satisfy the predetermined threshold, the selection component 716 may select a different subscription.

In an aspect, the selection component 716 may provide an indication of the selected subscription to a transmission component 710. The subscription component 706 may provide information associated with the selected subscription (e.g., information available from a SIM associated with the selected subscription). The transmission component 710 may be configured to connect to a destination network (e.g., a network on which UE 750 is available) using the selected subscription.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

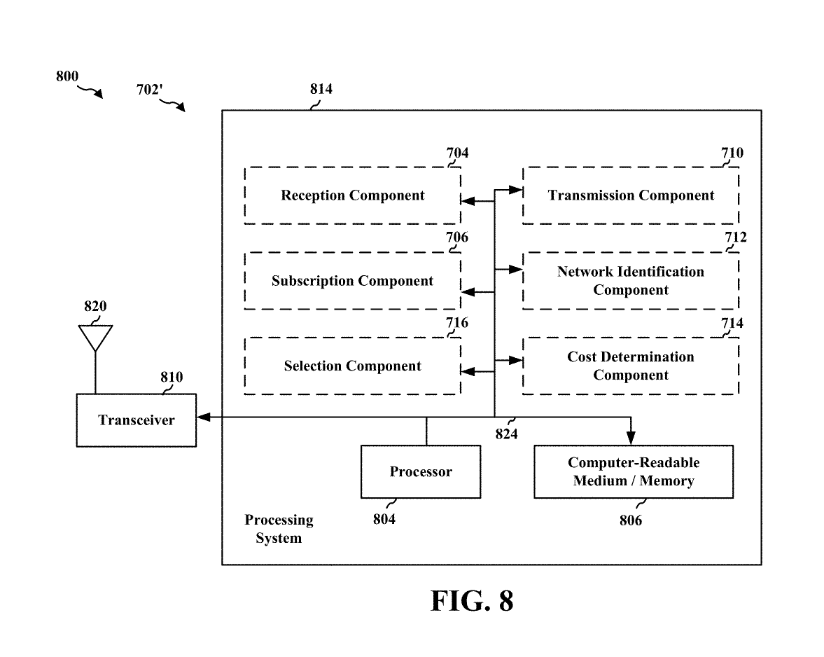

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 710, 712, 714, 716, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 710, 712, 714, 716. The components may be software components running in the processor 804, resident/stored in the computer readable medium/memory 806, one or more hardware components coupled to the processor 804, or some combination thereof. The processing system 814 may be a component of the UE 350 and may include the memory 360 and/or at least one of the TX processor 368, the RX processor 356, and the controller/processor 359.

In one configuration, the apparatus 702/702′ for wireless communication includes means for means for identifying a destination network. The apparatus 702/702′ may further include means for determining a first cost associated with connecting to the destination network using a first subscription of the apparatus. The apparatus 702/702′ may further include means for determining a second cost associated with connecting to the destination network using a second subscription of the apparatus. The apparatus 702/702′ may further include means for selecting the first subscription or the second subscription based on the first cost and the second cost. The apparatus 702/702′ may further include means for connecting to the destination network using the selected subscription.

In an aspect, the means for identifying the destination network is configured for: receiving a destination number; and identifying the destination network based on the destination number, wherein connecting to the network comprises establishing a voice call to the destination number. In an aspect, the means for identifying the destination network is configured for: receiving a destination address; and identifying the destination network based on the destination address, wherein connecting to the network comprises establishing a data connection to the destination address.

The apparatus 702/702′ may further include means for determining an available balance associated with the first subscription. The apparatus 702/702′ may further include means for comparing the available balance to a predetermined threshold, wherein the selection of the first subscription or the second subscription is further based on the comparison of the available balance to the predetermined threshold. In an aspect, the available balance corresponds to one of an amount of time, an amount of data, or an amount of money. In an aspect, the first cost is based on a first entry in a lookup table and the second cost is based on a second entry in the lookup table, and wherein the first entry corresponds to a cost per unit of time for connecting to the destination network using the first subscription and the second entry corresponds to a cost per unit of time for connecting to the destination network using the second subscription. In an aspect, the first entry and the second entry further correspond to at least one of a time frame in which the connection to the destination network is to be established or a region in which the connection is to be established. The apparatus 702/702′ may further include means for updating the lookup table based on subscriptions available at the apparatus. The apparatus 702/702′ may further include means for determining a first balance associated with the selected subscription prior to the connection to the destination network. The apparatus 702/702′ may further include means for determining a second balance associated with the selected subscription after the connection to the destination network. The apparatus 702/702′ may further include means for updating an entry in the lookup table corresponding to the selected subscription and the destination network based on a difference between the first balance and the second balance divided by a duration of the connection to the destination network. In an aspect, the means for selecting the first subscription or the second subscription is configured to further select based on at least one user preference. In an aspect, each subscription available at the apparatus corresponds to a respective subscriber identity module communicatively coupled with the apparatus. In an aspect, the first cost is based on a first entry in a lookup table and the second cost is based on a second entry in the lookup table, and wherein the first entry corresponds to a cost per unit of data for connecting to the destination network using the first subscription and the second entry corresponds to a cost per unit of data for connecting to the destination network using the second subscription.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of communication using a device having at least two subscriptions, the method comprising:
identifying a destination network;
determining a first cost associated with connecting to the destination network using a first subscription of a device;
determining a second cost associated with connecting to the destination network using a second subscription of the device;
selecting the first subscription or the second subscription based on the first cost and the second cost; and
connecting to the destination network using the selected subscription.

2. The method of claim 1, wherein identifying the destination network comprises:
receiving a destination number; and
identifying the destination network based on the destination number,
wherein connecting to the destination network comprises establishing a voice call to the destination number.

3. The method of claim 1, wherein identifying the destination network comprises:
receiving a destination address; and
identifying the destination network based on the destination address,
wherein connecting to the destination network comprises establishing a data connection to the destination address.

4. The method of claim 1, further comprising:
determining an available balance associated with the first subscription; and
comparing the available balance to a predetermined threshold,
wherein the selecting the first subscription or the second subscription is further based on the comparison of the available balance to the predetermined threshold.

5. The method of claim 4, wherein the available balance corresponds to one of an amount of time, an amount of data, or an amount of money.

6. The method of claim 1, wherein the first cost is based on a first entry in a lookup table and the second cost is based on a second entry in the lookup table, and wherein the first entry corresponds to a cost per unit of time for connecting to the destination network using the first subscription and the second entry corresponds to a cost per unit of time for connecting to the destination network using the second subscription.

7. The method of claim 6, wherein the first entry and the second entry each further correspond to at least one of a time frame in which a connection to the destination network is to be established or a region in which the connection is to be established.

8. The method of claim 6, further comprising:
updating the lookup table based on subscriptions available at the device.

9. The method of claim 6, further comprising:
determining a first balance associated with the selected subscription prior to a connection to the destination network;
determining a second balance associated with the selected subscription after the connection to the destination network; and
updating an entry in the lookup table corresponding to the selected subscription and the destination network based on a difference between the first balance and the second balance divided by a duration of the connection to the destination network.

10. The method of claim 1, wherein the selecting of the first subscription or the second subscription is further based on at least one user preference.

11. The method of claim 1, wherein each subscription available at the device corresponds to a respective subscriber identity module communicatively coupled with the device.

12. The method of claim 1, wherein the first cost is based on a first entry in a lookup table and the second cost is based on a second entry in the lookup table, and wherein the first entry corresponds to a cost per unit of data for connecting to the destination network using the first subscription and the second entry corresponds to a cost per unit of data for connecting to the destination network using the second subscription.

13. An apparatus having at least two subscriptions for wireless communication, the apparatus comprising:
means for identifying a destination network;
means for determining a first cost associated with connecting to the destination network using a first subscription of the apparatus;
means for determining a second cost associated with connecting to the destination network using a second subscription of the apparatus;
means for selecting the first subscription or the second subscription based on the first cost and the second cost; and
means for connecting to the destination network using the selected subscription.

14. The apparatus of claim 13, wherein the means for identifying the destination network is configured for:
receiving a destination number; and
identifying the destination network based on the destination number,
wherein connecting to the destination network comprises establishing a voice call to the destination number.

15. The apparatus of claim 13, wherein the means for identifying the destination network is configured for:
receiving a destination address; and
identifying the destination network based on the destination address,
wherein connecting to the destination network comprises establishing a data connection to the destination address.

16. The apparatus of claim 13, further comprising:
means for determining an available balance associated with the first subscription; and
means for comparing the available balance to a predetermined threshold,
wherein the selection of the first subscription or the second subscription is further based on the comparison of the available balance to the predetermined threshold.

17. The apparatus of claim 16, wherein the available balance corresponds to one of an amount of time, an amount of data, or an amount of money.

18. The apparatus of claim 13, wherein the first cost is based on a first entry in a lookup table and the second cost is based on a second entry in the lookup table, and wherein the first entry corresponds to a cost per unit of time for connecting to the destination network using the first subscription and the second entry corresponds to a cost per unit of time for connecting to the destination network using the second subscription.

19. The apparatus of claim 18, wherein the first entry and the second entry each further correspond to at least one of a time frame in which a connection to the destination network is to be established or a region in which the connection is to be established.

20. The apparatus of claim 18, further comprising:
means for updating the lookup table based on subscriptions available at the apparatus.

21. The apparatus of claim 18, further comprising:
means for determining a first balance associated with the selected subscription prior to a connection to the destination network;
means for determining a second balance associated with the selected subscription after the connection to the destination network; and
means for updating an entry in the lookup table corresponding to the selected subscription and the destination network based on a difference between the first balance and the second balance divided by a duration of the connection to the destination network.

22. The apparatus of claim 13, wherein the means for selecting the first subscription or the second subscription is configured to further select based on at least one user preference.

23. The apparatus of claim 13, wherein each subscription available at the apparatus corresponds to a respective subscriber identity module communicatively coupled with the apparatus.

24. The apparatus of claim 13, wherein the first cost is based on a first entry in a lookup table and the second cost is based on a second entry in the lookup table, and wherein the first entry corresponds to a cost per unit of data for connecting to the destination network using the first subscription and the second entry corresponds to a cost per unit of data for connecting to the destination network using the second subscription.

25. An apparatus having at least two subscriptions for wireless communication, the apparatus comprising:
a memory; and
at least one processor coupled to the memory and configured to:
identify a destination network;
determine a first cost associated with connecting to the destination network using a first subscription of the apparatus;
determine a second cost associated with connecting to the destination network using a second subscription of the apparatus;
select the first subscription or the second subscription based on the first cost and the second cost; and
connect to the destination network using the selected subscription.

26. The apparatus of claim 25 wherein the at least one processor is configured to identify the destination network based on:
receiving a destination number; and
identifying the destination network based on the destination number,
wherein connecting to the network comprises establishing a voice call to the destination number.

27. The apparatus of claim 25, wherein the at least one processor is configured to identify the destination network based on:
receiving a destination address; and
identifying the destination network based on the destination address,
wherein connecting to the network comprises establishing a data connection to the destination address.

28. The apparatus of claim 25, wherein the at least one processor is further configured to:
determine an available balance associated with the first subscription; and
compare the available balance to a predetermined threshold,
wherein the selection of the first subscription or the second subscription is further based on the comparison of the available balance to the predetermined threshold.

29. The apparatus of claim 25, wherein the first cost is based on a first entry in a lookup table and the second cost is based on a second entry in the lookup table, and wherein the first entry corresponds to a cost per unit of time for connecting to the destination network using the first subscription and the second entry corresponds to a cost per unit of time for connecting to the destination network using the second subscription.

30. A computer-readable medium storing computer-executable code for wireless communication by a device having at least two subscriptions, comprising code to:
identify a destination network;
determine a first cost associated with connecting to the destination network using a first subscription of a device;
determine a second cost associated with connecting to the destination network using a second subscription of the device;
select the first subscription or the second subscription based on the first cost and the second cost; and
connect to the destination network using the selected subscription.
